(19) United States
(12) Patent Application Publication
(10) Pub. No.: US 2001/0027116 A1
(43) Pub. Date: Oct. 4, 2001

(54) Electronic wallet

(75) Inventor: James B. Baird, Dundee (GB)

Correspondence Address: Michael Chan, Intellectual Property Section, Law Department, NCR Corporation, 101 West Schantz, ECD-2, Dayton, OH, 45479-0001, US

(73) Assignee: NCR Corporation

(21) Appl. No.: 09/815,373

(22) Filed: Mar. 22, 2001

(30) Foreign Application Priority Data
Mar. 28, 2000 (GB) 0007360.1

(51) Int. Cl. H04M 1/00

(52) U.S. Cl. 455/550; 455/556; 455/405; 455/407

(57) ABSTRACT

A method of making an electronic currency value available to a user is described. The method comprises the steps of: verifying the identity of the user, via a portable communications device; and identifying a currency value available to the user; said currency value being accessible via said portable communications device. Apparatus for accessing electronic currency is also described. The apparatus comprises: means for verifying the identity of a user; data processing means for responding to user instructions; means for communicating user instructions to the data processing means; and a portable communications facility for sending and receiving data to and from the apparatus.

### BACKGROUND OF THE INVENTION

The present invention relates to an electronic currency storage and manipulation device to be carried on the person of a user. The invention further relates to a method of storing electronic currency securely.

The area of “electronic currency” has grown substantially in recent years. While electronic transfers of currency between organizations and banking bodies is commonly used where traceability is not an issue, electronic currency has the advantage that, like cash, the parties are not identifiable in the transaction.

Several means of generating and using electronic currency exist; typically a unique number is generated to serve as a individual “coin”, representing a particular monetary value (for example, 1 euro). This number is then “certified” by the currency issuer as being worth 1 euro.

When a user wishes to spend some of their currency, the number is passed to a merchant, who verifies each “coin” with the issuing party, which records each “coin” as it is used, to ensure that each “coin” may only be used once. The issuer reimburses the merchant to the value of the coins, having previously deducted the same value from the user's account.

In order that electronic currency may be readily accessed for purchases without a need to generate coins at every transaction, it is often desirable for an individual to store previously-created coins.

One portable storage device currently used is a “smart card”, typically in the form of a plastics card with a memory device mounted thereon, the memory device being used to record data representing a selection of electronic coins. When the user desires to make a transaction, the card is inserted into an appropriate reader, and the necessary data transfers carried out.

However, smart card technology suffers from a number of disadvantages, which have hindered its adoption for certain transactions. One problem is that electronic currency, like cash, does not require authorization for its use. For example, if a smart card is stolen, the thief may use the certified currency values as if they were their own. Further, like cash, if the card is lost the electronic currency is lost also. An additional problem is the expense of providing users and merchants with the necessary smart cards and reader technology; this has slowed the take-up of this new technology.

### SUMMARY OF THE INVENTION

It is among the objects of embodiments of the present invention to obviate or alleviate these and other disadvantages of electronic currency systems. This may be achieved, in part, by combining aspects of electronic currency systems with elements of existing mobile communications technology.

According to a first aspect of the present invention, there is provided a method of making an electronic currency value available to a user, the method comprising the steps of:

verifying the identity of the user, via a portable communications device; and

identifying a currency value available to the user;

said currency value being accessible via said portable communications device.

Thus, embodiments of the present invention enable a user to be identified and to access only that currency which they are authorized to access, by means of a portable communications device, such as a mobile telephone.

Preferably, identification of the currency value requires prior verification of the user's identity.

Alternatively, or in addition, accessing of the currency value requires prior verification of the user's identity.

These steps ensure that use of the currency is reliant upon satisfactory verification of the user's identity. Therefore unauthorized users will be unable to make use of another individual's currency.

Preferably, verification of the user's identity makes use of a biometrics identifier; for example, the user's iris or fingerprint characteristics, or the user's voice. Methods of biometrics verification will be known to those of skill in the art.

In a preferred embodiment of the method of the present invention, the method further comprises the step of storing said currency value in a storage means provided in said portable communications device. Alternatively, the method may comprise the step of storing said currency value in a storage means accessible via said portable communications device. Preferably, the stored currency value is encrypted by means of an algorithm dependent at least in part on a biometrics characteristic of the user. Therefore, the currency may only be accessed by a user presenting an appropriate biometrics identifier.

According to a second aspect of the present invention, there is provided an apparatus for accessing electronic currency, the apparatus comprising:

means for verifying the identity of a user;

data processing means for responding to user instructions;

means for communicating user instructions to the data processing means; and

a portable communications facility, for sending and receiving data to and from the apparatus.

An apparatus according to the present invention provides a medium for storage and handling of electronic currency, while being capable of data communication with a remote location, thereby eliminating the need for separate electronic currency smart card readers. The user recognition means may also be used to provide a measure of security to stored currency, such that only an authorized user may access the currency.

Preferably, the user verification means comprises a biometrics recognition device. For example, the device may determine a particular characteristic of a user's fingerprint, iris, or voice, in order to compare the determined characteristic against a reference characteristic. Alternative user verification means may be used, for example, a secret password or numeric code communicated to the data processing means, or the like.

In a preferred embodiment, the apparatus may further comprise data storage means for storing certificated electronic currency values These currency values may or may not be encrypted, for example with an encryption algorithm derived in part from a particular user's biometric characteristics. In an alternative embodiment, certificated and possibly encrypted electronic currency values are stored remotely, and accessed by means of the portable communications facility. A mixture of these types of storage may also be used, with some currency stored locally, and some remotely.

Preferably the data processing means may include means for encrypting and/or decrypting data. Preferably also the encryption/decryption means may make use of an algorithm derived in part from a particular user's biometric characteristics. This ensures that each user may use only their own currency: measured biometrics characteristics are used to access a data sequence which has previously been encrypted with the same biometrics characteristics, whether remotely or locally. In this way several different individuals' currency may be stored on the same apparatus, and each user may only access their own currency. Further, the use of this method of encryption/decryption means that it is not necessary for a positive identification of every user to occur, but merely to make available to a user whichever data provides a meaningful output (that is, a currency value) when decrypted with that user's particular characteristics. The task of user recognition is thereby greatly simplified.

Preferably the communications facility may be used for data communication with a mobile telephony network. Preferably the apparatus may function as a mobile communications device. For example, the apparatus may comprise a mobile telephone.

Preferably the apparatus further comprises a local data communications facility. For example, the apparatus may comprise one or more infra-red or other electromagnetic radiation communications ports, or may use low-powered radio signals, or the like. This may be used in order to communicate data locally (for example, with a merchant's electronic “cash register”) without the requirement to be in contact with a remote location (such as a central mobile communications “hub”). For example, the facility may be used to transfer certificated currency values from the data storage means to a second apparatus of this or another aspect of the present invention, or to a merchant's electronic currency “till” or the like. Transactions in electronic currency may thereby be conducted in a relatively rapid and straightforward manner, and do not require the user to be in contact with a remote location (for example, if a mobile telephone signal is weak).

According to a third aspect of the present invention, there is provided a method of securely storing electronic currency values, the method comprising the steps of:

obtaining a biometrics identifier from a user;

generating a request for a certificated currency value;

sending said request to a certified currency issuer;

obtaining a certified currency value from said issuer;

encrypting said certified currency value in a manner dependent at least in part on said biometrics identifier; and

storing the encrypted certified currency value.

This aspect of the present invention provides a method of storing currency values encrypted in such a way that only the owner of the currency may access these values. The encryption itself may be performed locally (for example, by a portable communications device), or remotely (for example, by the currency issuer itself). There is further no necessity to recognize or match the biometrics identifier in order to verify the user, since the encrypted currency will only be accessible to a user presenting the appropriate biometrics identifier to successfully decrypt the currency values. Certain embodiments of the invention may nonetheless incorporate validation of the user's identity in the invention if desired; for example, as an additional layer of security, to ensure that unauthorized individuals may not even access the encrypted currency values.

According to a fifth aspect of the present invention there is provided a method of accessing stored electronic currency, the method comprising the steps of:

obtaining a biometrics identifier from a user;

decrypting an encrypted certificated currency value in a manner dependent at least in part on said biometrics identifier; and

transferring the decrypted certificated currency value to a third party, such as a vendor.

Again, the method of this aspect of the present invention ensures that each user may only access their own encrypted currency values; if an unauthorized individual attempts to access the currency, the decryption algorithm will not yield a decrypted currency value.

### BRIEF DESCRIPTION OF THE DRAWINGS

These and other aspects of the present invention will now be described, by way of example only, with reference to the accompanying drawings, in which:

FIG. 1 illustrates an apparatus for manipulating electronic currency, in accordance with an embodiment of an aspect of the present invention, in the form of a mobile telephone;

FIG. 2 shows a block circuit diagram of components accommodated within the apparatus of FIG. 1; and

FIG. 3 illustrates a network and the step of transactions involving electronic currency and the apparatus of FIGS. 1 and 2.

### DETAILED DESCRIPTION

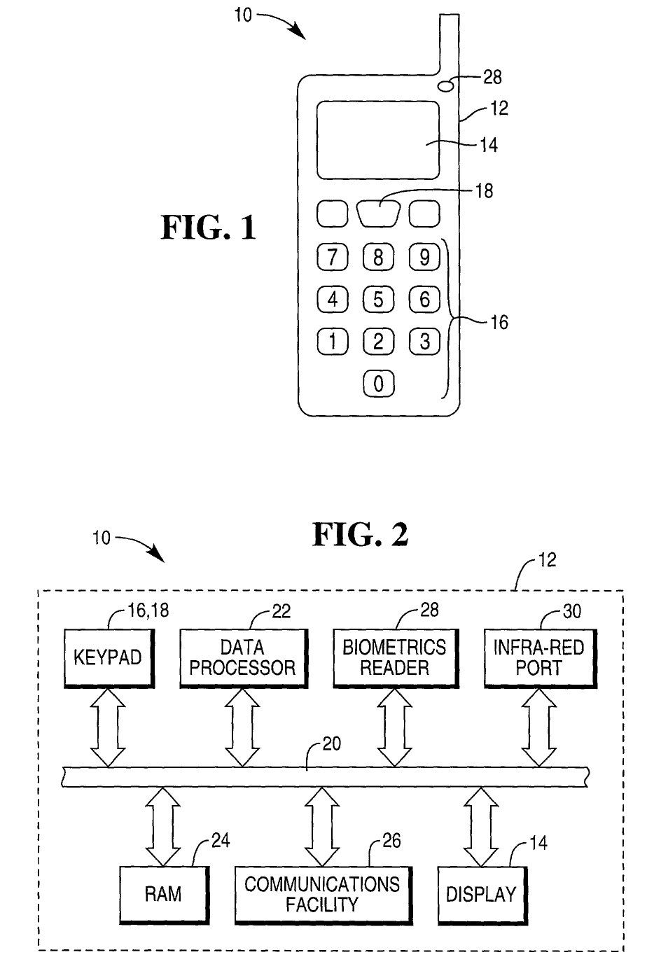

Referring now to FIG. 1, there is shown an apparatus 10 for manipulating electronic currency in accordance with one embodiment of an aspect of the present invention, in the form of a mobile telephone. The telephone 10 comprises a plastics outer casing 12 which accommodates a display screen 14 and a numeric keypad 16. Additional multifunction keys 18 are also provided. Further functional items, as will be described, are housed within the casing 12 and are not normally visible to a user.

FIG. 2 illustrates schematically the functional components of the apparatus 10. The casing 12 is shown as a dotted line rectangle. A data bus 20 connects a data processor 22, the numeric keypad 16 and multifunction keys 18, a random access memory 24, a portable electronic communications facility 26, a biometrics reader 28, the display screen 14, and an infra-red local communication port 30. The biometrics reader 28 may take the form of a fingerprint reader, an iris scanner, a voice recognition module, or the like.

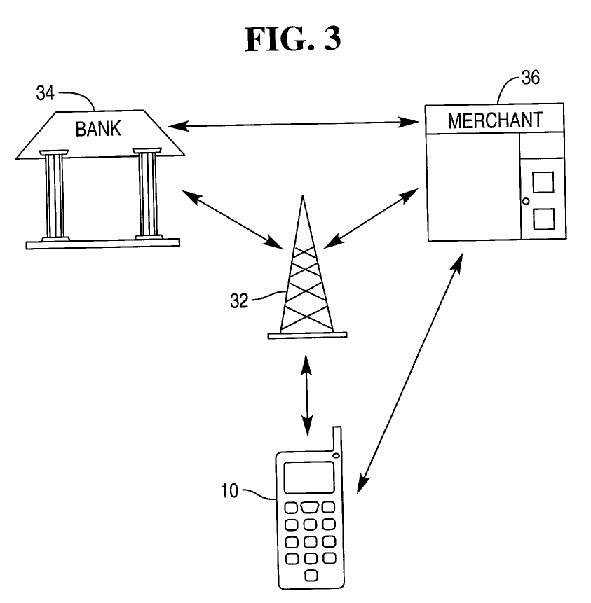

FIG. 3 shows a series of steps involved in typical electronic currency transactions, including a mobile telephone 10, a mobile telephony base station 32, an electronic currency issuer 34, and a merchant 36. Double-headed arrows represent avenues of communication between the component parts of the network.

In order to store electronic currency securely on the telephone 10, the following sequence of events is conducted. Using the numeric keypad 16 and function keys 18, a user selects the appropriate option from a menu displayed by the telephone 10. The biometrics reader 28 then acquires an image of, for example, the user's iris. This is then digitized to provide a unique biometrics identifier. The communications facility 26 is then used to pass a request for currency via a telecommunications base station 32 to an electronic currency issuer 34 with which the user has an account. If desired, the biometrics identifier may be used to verify the identity of the user by comparing the sampled identifier with a reference identifier for authorized users, either locally by the mobile telephone 10, or remotely, by the currency issuer 34.

The issuer 34 generates certificated currency values to the desired amount, and transmits these back to the telephone 10 via the base station 32. The unencrypted values are then encrypted locally by the data processor 22 using an algorithm derived at least in part from the user's biometrics identifier. Receipt of the currency is acknowledged by the telephone 10, and the encrypted values are then stored in the telephone's RAM 24, until needed. In the case of a mobile telephone, the RAM 24 may form a part of the telephone's SIM.

Alternatively, the encryption may take place remotely, by the currency issuer 34. In this case, the biometrics identifier is passed to the issuer 34 together with a request for currency; and an encrypted certified currency value is returned to the telephone 10.

The encrypted values are also stored with an unencrypted token indicating the value and/or owner of the currency. Either of these methods may also incorporate an additional security measure if desired, by comparing the user's biometrics identifier against a stored reference identifier for that user in order to verify the user's identity. Only verified users would be permitted to make use of the currency storage and manipulation facilities of the telephone. This comparison may take place either locally, in the telephone 10, or remotely, at the currency issuer 34.

Once the encrypted currency values have been stored in the RAM 24 of the telephone 10, the user may wish to purchase goods or services from a merchant 36.

In order to access the currency, the user enters the appropriate details of the desired currency transaction by means of the numeric and function keypads 16, 18 and the screen 14. The data processor 22 then retrieves suitable encrypted ‘coins’ to the desired total value from the telephone's RAM 24. A biometric measurement is taken of the user by the biometrics reader 28 (for example, an iris scan), and an identifying value is passed to the data processor 22. This value is then used as the basis for a decryption algorithm to operate on the encrypted currency values, yielding unencrypted certified currency values. If an unauthorized user attempts to access the currency, their biometrics will not yield unencrypted currency values, but rather meaningless data. Thus only the currency owner may have access to their currency.

The encrypted currency values are then passed to the merchant's electronic ‘cash register’ 36, either directly by means of the short range infra-red communications port or the like, or indirectly via communications facility 26 and a mobile telephony base station 32.

The merchant 36 may verify the currency with the issuer 34 again either by a direct dedicated network link or via a more general communications network, and may possibly issue “change” to the user, in the form of new certificated currency values.

As an alternative to, or in addition to, the methods described above, the RAM 24 may be situated remotely from the telephone 10, for example with the currency issuer 34. In this case the encrypted currency values are stored remotely, and access to the issuer 34 is required for every transaction. The decryption process will be somewhat modified in this embodiment also, as the biometrics identifier will be passed to the issuer 34 for decryption as well as encryption.

It can be seen from the foregoing that the present invention provides a robust and straightforward means of conducting electronic currency transfers and transactions, and of storing currency values, in such a way that only the currency owner may have access to their money. Further, the provision of the storage and access means in the form of a mobile telecommunications device takes advantage of an already widespread technology. The invention also removes the requirement for users and merchants to acquire specialized smart card readers and the like.

What is claimed is:

1. A method of making an electronic currency value available to a user, the method comprising the steps of:
verifying the identity of the user via a portable communications device;
identifying a currency value which is accessible to the user via the portable communications device.

2. A method according to claim 1, wherein the step of identifying a currency value requires prior verification of the user's identity.

3. A method according to claim 1, further comprising the step of:
storing the currency value in a storage medium provided in the portable communications device.

4. Apparatus for accessing electronic currency, the apparatus comprising:
user verification means for verifying the identity of a user;
data processing means for responding to user instructions;
means for communicating user instructions to the data processing means; and
a portable communications facility for sending and receiving data.

5. Apparatus according to claim 4, wherein the user verification means comprises a biometrics recognition device.

6. Apparatus according to claim 4, further comprising data storage means for storing certificated electronic currency values.

7. Apparatus according to claim 4, wherein the data processing means includes means for encrypting and/or decrypting data.

8. Apparatus according to claim 4, wherein the portable communications facility is connectable in data communication with a mobile telephony network.

9. Apparatus according to claim 4, further comprising a local data communications facility.

10. A mobile communications device for allowing a user to access electronic currency, the device comprising:
user verification means for verifying the identity of a user;
data processing means for responding to user instructions;
means for communicating user instructions to the data processing means; and
a portable communications facility for sending and receiving data.

11. A mobile communications device according to claim 10, wherein the user verification means comprises a biometrics recognition device.

12. A mobile communications device according to claim 10, further comprising data storage means for storing certificated electronic currency values.

13. A mobile communications device according to claim 10, wherein the data processing means includes means for encrypting and/or decrypting data.

14. A mobile communications device according to claim 10, wherein the portable communications facility is connectable in data communication with a mobile telephony network.

15. A method of securely storing electronic currency values, the method comprising the steps of:
obtaining a biometrics identifier from a user;
generating a request for a certificated currency value;
sending the request to a certified currency issuer;
obtaining a certified currency value from the issuer;
encrypting the certified currency value in a manner dependent at least in part on the biometrics identifier; and
storing the encrypted certified currency value.
